(19) United States
(12) Patent Application Publication
(10) Pub. No.: US 2007/0138802 A1
(43) Pub. Date: Jun. 21, 2007

(54) MOTOR VEHICLE LOCK

(75) Inventors: Jakub Stasko, Ostrava-Jih (CZ); Juergen Zietlow, Wuppertal (DE); Simon Brose, Hattingen (DE)

Correspondence Address: ROBERTS, MLOTKOWSKI & HOBBES, P. O. BOX 10064, MCLEAN, VA, 22102-8064, US

(73) Assignee: BROSE SCHLIESSSYSTEME GMBH & CO. KG, Wuppertal (DE)

(21) Appl. No.: 11/567,887

(22) Filed: Dec. 7, 2006

(30) Foreign Application Priority Data
Dec. 7, 2005 (DE) 20 2005 019 198.1
Oct. 11, 2006 (EP) 06 021 313.9

(51) Int. Cl. E05C 3/06

(52) U.S. Cl. 292/201

(57) ABSTRACT

A motor vehicle lock with a latch and an assigned ratchet, an opening drive for motorized lifting of the ratchet, a flexible traction mechanism and a guide pulley which is located on the ratchet or on a rocker arm which is assigned to the ratchet, the traction mechanism being coupled by drive engineering on its first end to the opening drive and the traction mechanism being guided via the guide pulley. The traction mechanism together with the guide pulley provides a pulley arrangement to lift the ratchet. An emergency actuation arrangement is provided for manually lifting the ratchet and a second end of the traction mechanism is coupled by drive engineering to the emergency actuation arrangement.

### BACKGROUND OF THE INVENTION

1. Field of the Invention

This invention relates to a motor vehicle lock with a latch and an assigned ratchet, an opening drive for motorized lifting of the ratchet, a flexible traction mechanism and a guide pulley which is located on the ratchet or on a rocker arm which is assigned to the ratchet, the traction mechanism being coupled by drive engineering on its first end to the opening drive, the traction mechanism acting via the pulley to lift the ratchet. The expression “motor vehicle lock” is defined primarily as the door lock of a motor vehicle. But it can also be a trunk lock, a hood lock, a hatch lock or the like of a motor vehicle.

2. Description of Related Art

The motor vehicle lock under consideration is equipped with latching elements, the latch and ratchet. An enhanced function for this motor vehicle lock which is acquiring increasing importance consists in the motorized lifting of the ratchet by means of an opening drive. The known motor vehicle lock of commonly-owned German Patent Application DE 103 56 306 A1 and corresponding U.S. Patent Application Publication 2005/0134054 A1 underly the present invention and show such an opening drive. The opening drive here is coupled by drive engineering to a rocker arm assigned to the ratchet via a flexible traction mechanism. In this connection, in one alternative, the traction mechanism together with a guide pulley roller located on the rocker arm forms a pulley block-like arrangement for lifting the ratchet. Simple implementation and quiet operation are especially advantageous here.

In a motor vehicle lock with auxiliary motorized opening function, the question arises of the operating behavior of the vehicle lock in emergency operation, for example, when the electrical power supply fails. For this case, there is generally a mechanical redundancy. This means that the ratchet can be lifted manually, i.e., without the opening drive. Another known motor vehicle lock (German Patent Application DE 195 01 493 A1 and corresponding U.S. Pat. No. 5,697,236) has an opening drive and additionally has an emergency actuation Bowden cable for manual lifting of the ratchet.

In conjunction with the use of flexible traction mechanisms in motor vehicle locks, another known motor vehicle lock (German Patent Application DE 106 04 724 A) provides for manual lifting of the ratchet via a cable pull. The cable pull can be moved into the tensioned and untensioned state via an adjustable rope sheave in order to lock and unlock the motor vehicle lock. There is no motorized lifting of the ratchet here.

### SUMMARY OF THE INVENTION

A primary object of the present invention is to embody and develop the known motor vehicle lock such that mechanical redundancy is easily provided.

The aforementioned object is achieved in a motor vehicle lock with the features noted above in which a emergency actuation means for manually lifting the ratchet is coupled by drive engineering to the traction mechanism.

What is first of all important is the consideration that the pulley arrangement can be advantageously used for lifting the ratchet for the auxiliary opening function, on one hand, and for emergency actuation, on the other. In this connection the traction mechanism on its first end is coupled by drive engineering to the opening drive and on its second end by drive engineering to the emergency actuation means.

In the approach in accordance with the invention, the two functions “motorized lifting of the ratchet” and “manual lifting of the ratchet” are implemented with a single mechanism, specifically with a pulley arrangement. This leads to an especially simple arrangement in terms of design.

In motorized lifting of the ratchet by the opening drive, the emergency actuation means provides the necessary abutment for the motorized driving force. Furthermore, when the ratchet is manually lifted by the emergency actuation means the opening drive provides the necessary traction mechanism for the manual driving force.

One especially economical and reliable configuration involves the drive shaft of the drive motor of the opening drive being used to wind and unwind the traction mechanism. Since the drive shaft is present anyway, an additional take-up device can be saved.

According to another teaching which acquires independent importance, the aforementioned object in a motor vehicle lock is achieved by the driving force being directed essentially perpendicular to the extension of the traction mechanism at the engagement point, and for lifting of the ratchet, being transmitted to the traction mechanism by means of the opening drive at the engagement point between the two ends of the traction mechanism.

What is important here is the consideration that, under certain assumptions, the delivery of a driving force which is directed essentially perpendicular to the extension of the traction mechanism can be advantageous.

The traction mechanism is coupled here by drive engineering on its first end to the ratchet or to the rocker arm assigned to the ratchet and is supported on its second end. Transmission of the motorized driving force which is directed perpendicular to the extension of the traction mechanism at the engagement point also causes a traction force acting on the ratchet and with a suitable design the motorized lifting of the ratchet. Here is it is especially advantageous if the traction mechanism is tensioned between the ratchet and the abutment at any instant.

In addition to the manner of lifting the ratchet described last, the ratchet can also be lifted in the conventional manner via the traction mechanism, specifically by delivering a driving force on the second end of the traction mechanism, the driving force being aligned essentially parallel to the extension of the traction mechanism on its second end. This type of lifting of the ratchet is preferably assigned to the emergency actuation means.

The opening drive can also be made to be manually actuated. In this connection, the manual driving force preferably goes back to the actuation of an inside door handle or an outside door handle. Then, there will generally not be a manual emergency actuation means.

In preferred configurations, the opening drive is equipped with an actuating lever which can be pivoted around an actuating lever axis which has an engagement element for engaging the traction mechanism and which has a point of application of force, especially a point of application of force apart from the actuating lever axis, for delivering a manual or motorized actuating force.

One suitable design of the actuating lever can lead to a modular configuration of the motor vehicle lock such that two different versions of the motor vehicle lock can be implemented with the same structure.

In preferred embodiments, the actuating lever is used to deflect the traction mechanism at the engagement point, by which the ratchet can be raised with a small driving force (first version).

In another preferred configuration, the actuating lever is additionally made such that it can be equipped with a driver which engages the ratchet and raises it when the actuating lever pivots and when the traction mechanism is omitted (second version). Compared to the first version, generally an increased driving force is necessary in this second version.

Both versions can be advantageous with regard to functional, but also cost aspects for certain applications.

The two versions can be produced by the same structure with a corresponding design on the same production facility; this leads to especially low production costs.

Other details, features, objectives and advantages of this invention are explained in detail below with reference to the accompanying drawings.

### BRIEF DESCRIPTION OF THE DRAWINGS

FIG. 1 schematically shows a motor vehicle lock in accordance with the invention when the latch is in the main catch position,

FIG. 2 shows the motor vehicle lock of FIG. 1 in the state actuated by the opening drive,

FIG. 3 shows the motor vehicle lock of FIG. 1 in the state actuated by the emergency actuation means,

FIG. 4 schematically shows a motor vehicle lock in accordance with the invention when the latch is in the main catch position according to another independent teaching in a top view,

FIGS. 5a & 5b show the motor vehicle lock according to FIG. 4 in a section taken along line V-V with the latch in the main catch position and in the state actuated by the opening drive, respectively, and

FIG. 6 is a perspective of a cam arrangement of the motor vehicle lock as shown in FIG. 4,

FIG. 7 schematically shows a motor vehicle lock in accordance with the invention according to another embodiment in a top view,

FIG. 8 schematically shows a motor vehicle lock in accordance with the invention according to another embodiment when the latch is in the main catch position,

FIG. 9 shows the motor vehicle lock as shown in FIG. 8 in the state actuated by the opening drive,

FIG. 10 schematically shows a motor vehicle lock in accordance with the invention according to yet another embodiment in a top view.

### DETAILED DESCRIPTION OF THE INVENTION

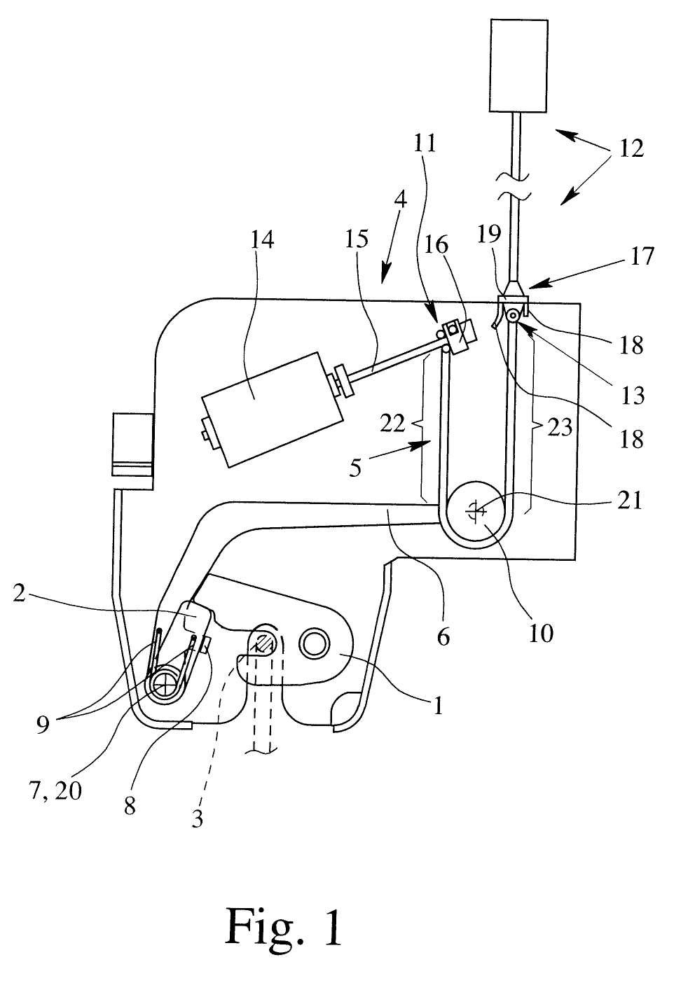

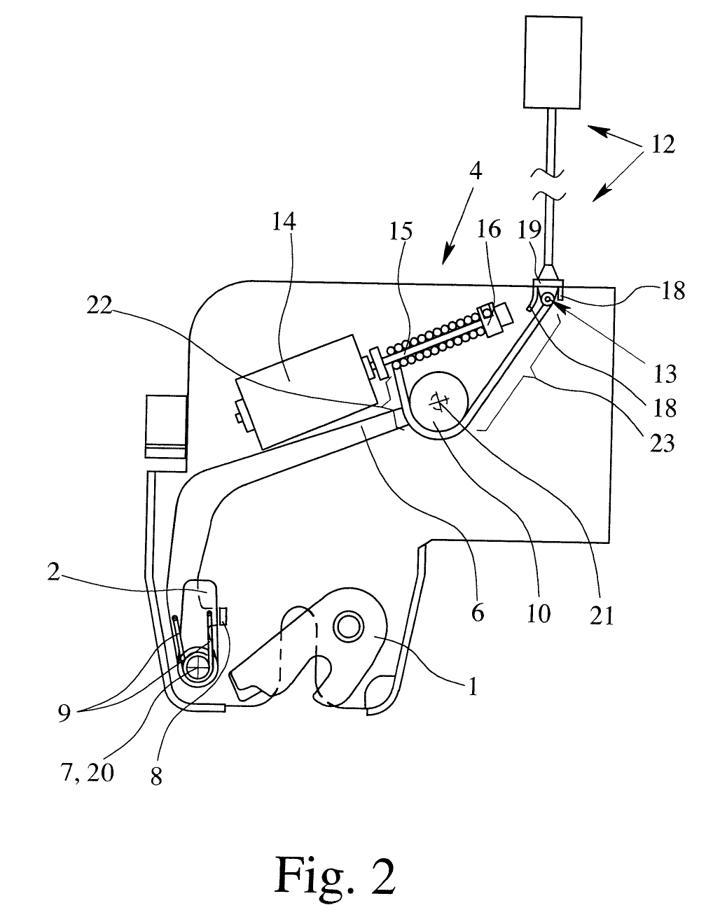

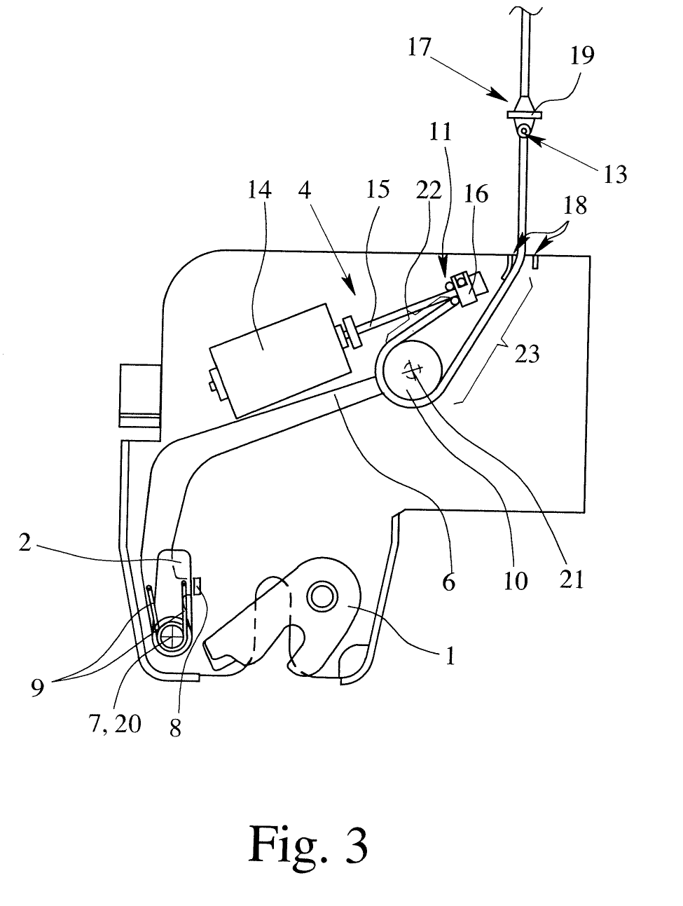

The motor vehicle lock shown in FIG. 1 is equipped with the conventional latching elements, the latch 1 and ratchet 2. In the engaged state, the ratchet 2 holds the latch 1 in its main catch position shown in FIG. 1. In this state, the latch 1 is engaged with the striker 3 which is conventionally located on the body of the motor vehicle. FIGS. 2 & 3 show the ratchet 2 in its lifted position in which the latch 1 has been released. The latch 1 can be moved here exclusively into the closed position (FIGS. 2, 3) and into the main catch position (FIG. 1). But it is also fundamentally possible to assign a half-catch position to the latch 1. However, this plays no part for the design in accordance with the invention.

The motor vehicle lock is equipped with an opening drive 4 for motorized lifting of the ratchet 2. The opening drive 4 is coupled by drive engineering to the ratchet 2 via a flexible traction mechanism 5. This coupling can be made direct or indirect.

In the illustrated preferred embodiment, the drive engineering coupling between the opening drive 4 and the ratchet 2 is an indirect coupling, specifically coupling via a rocker arm 6 which is assigned to the ratchet 2. The rocker arm 6 can be pivoted around a pivot axis 7 and is coupled to the ratchet 2 by way of a driver 8 located on the rocker arm 6 and by way of a spring 9. The ratchet 2 and the arrangement comprised of the ratchet 2 and rocker arm 6 are also pretensioned by a spring arrangement (not shown) in the direction of the engaged position, in FIG. 1 around to the right. Instead of the arrangement comprised of the ratchet 2 and rocker arm 6, there can also be exclusively a ratchet 2 with a correspondingly projecting arm or the like.

On the rocker arm 6, there is a guide pulley 10. In the above-mentioned arrangement, without the rocker arm 6, the guide pulley 10 is located accordingly on the ratchet 2.

At this point, the traction mechanism 5 is coupled by drive engineering on its first end 11 to the opening drive 4 and is guided via the guide pulley 10. In this connection, the traction mechanism 5, together with the guide pulley 10, forms a pulley arrangement for lifting the ratchet 2.

What is important at this point is that there is an emergency actuation means 12 for manual lifting of the ratchet 2. In this connection, the second end 13 of the traction mechanism 5 is coupled by drive engineering to the emergency actuation means 12. Numerous versions are possible for actuating the emergency actuation means 12. One possibility is for actuation to be produced via a locking cylinder.

Both the opening drive 4 and also the emergency actuation means 12 are made such that they can deliver a tension force to the traction mechanism 5, from which a driving motion results.

At this point, if a corresponding driving force is delivered from the opening drive 4 to the first end 11 of the traction mechanism 5, the emergency actuation means 12 forms an abutment for the motorized driving force of the opening drive 4. It is provided for this purpose that the emergency actuation means 12 in the non-actuated state fixes the second end 13 of the traction mechanism 5.

On the other hand, the opening drive 4, with manual actuation by the emergency actuation means 12, forms an abutment for the manual driving force of the emergency actuation means 12.

The abutment is provided especially easily as described above by the opening drive 4 in the illustrated preferred embodiment. Here, it is provided that the opening drive 4, as described, has a drive motor 14 with a drive shaft 15, and the traction mechanism 5 can preferably be taken up directly on the drive shaft 15. Fundamentally, there can of course also be gearing between the drive motor 14 and the drive shaft 15. FIG. 1 shows that with the ratchet 2 engaged, the traction mechanism 5 is unwound completely from the drive shaft 15 so that a tension force acting from the emergency actuation means 12 on the traction mechanism 5 cannot cause any winding/unwinding motion of the drive shaft 15. The tension force acts directly on the drive shaft 15 or on its bearing arrangement via a clamping part 16 which attaches the traction mechanism 5 to the drive shaft 15. The drive motor 14 together with the drive shaft 15 thus provides the above described abutment. However, for providing the abutment for the manual driving force of the emergency actuation means 12, it can also be provided that the drive motor 14 or the optionally present gearing is made self-locking.

Numerous versions are also possible for the design of the abutment by the emergency actuation means 12. In this embodiment, on the traction mechanism 5, there is a stopper element 17 which is permanently connected to the traction mechanism 5. FIG. 3 shows that, when the emergency actuation means 12 is actuated, the stopper element 17 is shifted up in FIG. 3. When the emergency actuation means 12 is released, the stopper element 17 engages the stop 18 located on the housing of the motor vehicle lock. For this purpose, the stopper element 17 has a shoulder 19 which corresponds to the stop 18.

It can be summarized that, in the motorized lifting of the ratchet 2, the traction mechanism 5 is taken up onto the drive shaft 15, while the emergency actuation means 12 as described provides the necessary abutment, therefore fixes the second end 13 of the traction mechanism 5. When the traction mechanism 5 is taken up, the traction mechanism 5 rolls off the guide pulley 10; as a result this leads to lifting of the ratchet (FIG. 2).

When the ratchet 2 is manually lifted, proceeding from the state shown in FIG. 1, the second end 13 of the traction mechanism 5 in FIG. 1 is shifted up. The opening drive 4 here makes available the necessary traction mechanism so that the ratchet 2, as shown in FIG. 3, is in turn lifted.

The above described operating principle of motorized and manual lifting of the ratchet 2 makes it clear that the approach in accordance with the invention has high durability; this is especially important for the emergency actuation means 12.

The ratchet 2 can be pivoted around the ratchet axis 20 which corresponds to the above addressed pivoting axis 7 of the rocker arm 6. In an especially preferred configuration, the deflection axis 21 of the guide pulley 10 is aligned essentially parallel to the ratchet axis 20. In this connection, the guide pulley 10 is spaced apart from the ratchet axis 20 on the ratchet 2 or on the rocker arm 6 assigned to the ratchet 2. The distance between the ratchet axis 20 and deflection axis 21 is determined by design boundary conditions, and also by the driving force which can be transmitted from the opening drive 4 and from the emergency actuation means 12.

Especially advantageous drive multiplication with the ratchet 2 engaged arises by the traction mechanism segment 22 between the opening drive 4 and the guide pulley 10 with the traction mechanism segment 23 between the emergency actuation means 12 and the guide pulley 10 including an angle that is as small as possible. This angle should be less than 120°. Advantageous results can also be achieved at an angle less than 90°. In the illustrated, preferred embodiment this angle is essentially 0°, the two traction mechanism segments 22, 23 are therefore arranged preferably parallel to one another.

Numerous possible configurations are possible for the configuration of the traction mechanism 5. The traction mechanism 5 can be made as a cable, belt or chain. For the case of making the traction mechanism 5 as a cable, a cable of plastic material is advantageous especially with respect to low noise development.

With the approach in accordance with the invention, a motorized opening aid, on the one hand, and manual emergency actuation, on the other, can be implemented in a simple design. The actuating forces are low due to the pulley arrangement for raising the ratchet 2, both for manual and also for motorized lifting of the ratchet 2. For both types of actuation, the traction mechanism 5 remains tensioned, so that an undefined arrangement of the traction mechanism 5 need not be tolerated at any time.

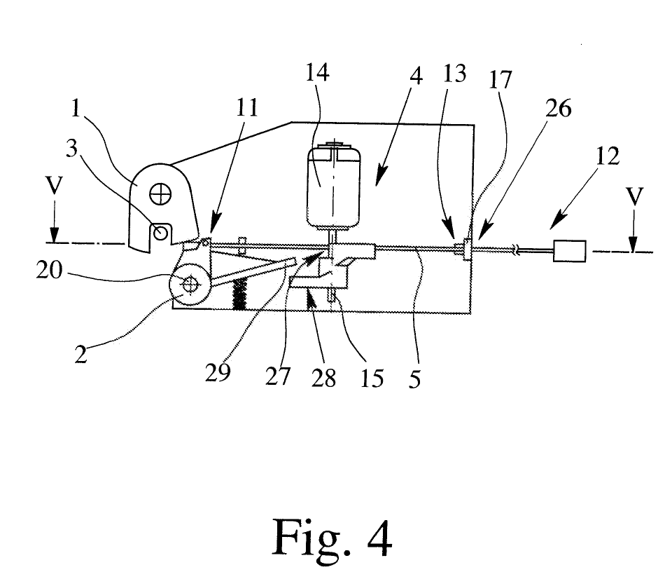

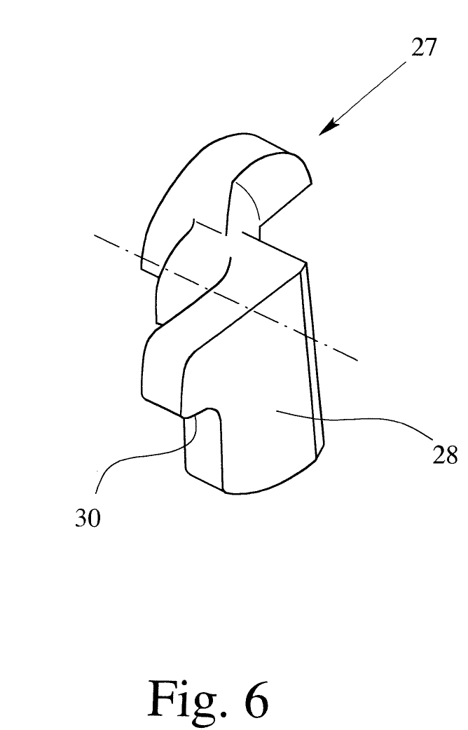

Another teaching which acquires independent importance relates to another possibility for lifting the ratchet 2 via a flexible traction mechanism 5. Here again, it is especially advantageous that only a single mechanism is necessary to implement the motorized lifting of the ratchet 2 on the one hand and manual lifting of the ratchet 2 on the other. FIGS. 4 to 6 show a preferred configuration according to this other teaching.

The motor vehicle lock shown in FIG. 4 has latching elements—the latch 1 and the ratchet 2. In this respect this motor vehicle lock corresponds to the motor vehicle lock shown in FIG. 1.

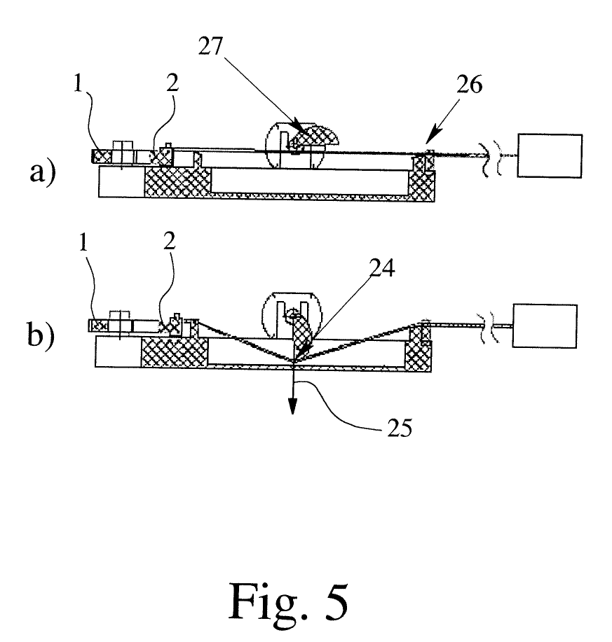

The motor vehicle lock shown in FIG. 4 is provided with an opening drive 4 for motorized lifting of the ratchet 2. There is a flexible traction mechanism 5 via which the opening drive 2 is or can be coupled by drive engineering to the ratchet 2. It can be taken from FIG. 5(a) that the opening drive 4, in this state, is (still) not coupled to the traction mechanism 5 so that the formulation “can be coupled” is correct here.

First of all, it is important that the first end 11 of the traction mechanism 5 is coupled by drive engineering to the ratchet 2—or to a rocker arm 6 assigned to the ratchet 2—and is supported on its second end 13. Examining FIGS. 5(a) & 5(b) together shows that by means of the opening drive 4 at one engagement site 24 between the two ends 11, 13 of the traction mechanism 5, a motorized driving force 25 can be transmitted to the traction mechanism 5 which is aligned essentially perpendicular to the extension of the traction mechanism 5 at the engagement point 24 and causes lifting of the ratchet 2. Therefore, it was recognized that the delivery of a drive force not only in the direction of extension of the traction mechanism 5, but also perpendicular to this extension can be advantageous.

In the illustrated, preferred embodiment it is such that the traction mechanism 5 is tensioned between the ratchet 2 and the abutment 26 at any instant. If, at this point, the aforementioned vertically aligned driving force is delivered to the traction mechanism 5, proceeding from the state shown in FIG. 5(a), the traction mechanism 5 is deflected down from the position in FIG. 5(a), by which the ratchet 2 is lifted.

In an especially preferred configuration, the opening drive 4 has a drive motor 14 with a drive shaft 15, and here also gearing can be interposed. The drive shaft 15 bears a cam arrangement 27 for transmitting the driving force from the opening drive 4 to the traction mechanism 5. Implementation of this cam arrangement 27 is especially advantageous in a design respect, since here largely any transmission ratio can be set which can even be changed depending on the angular position of the drive shaft 15. For this cam arrangement 27, it is such that the engagement point 24 is displaced during motorized positioning of the ratchet 2. When the engagement point 24 is addressed below, the current engagement point 24 is intended.

The drive shaft 15 here is aligned essentially perpendicular to the extension of the traction mechanism 5. This offers special advantages particularly with respect to the use of the cam arrangement 27, since the cam arrangement 27 thus engages the traction mechanism 5 in the optimum manner.

Other possibilities are also possible for delivering the vertically aligned driving force to the traction mechanism 5. A linear drive which is aligned perpendicular to the extension of the traction mechanism 5 with respect to its drive motion would also be possible. The configuration of the opening drive 4 with a cam arrangement 27 is especially advantageous in that this arrangement can be easily operated in the block mode.

Proceeding from the state shown in FIG. 5(a), the motorized lifting of the ratchet 2 starts by turning of the drive shaft 15 around to the left in FIG. 5(a). The traction mechanism 5 is deflected as shown in FIG. 5(b); this leads to lifting of the ratchet 2. In this connection, a guide surface 28 located on the cam arrangement 27 runs past an arm 29 of the ratchet 2 and keeps the ratchet 2 in the raised position. As the drive shaft 15 continues to turn, the guide surface 28 disengages from the arm 29 of the ratchet 2, by which the ratchet 2 with its arm 29 drops into the range of motion of a stop 30 on the cam arrangement 27. The stop 30 runs against the arm 29 of the ratchet 2, by which the drive shaft 15 is blocked in its blocking position. The blocking position is here preferably the position shown in FIG. 5(a), therefore the initial position of the drive shaft 15.

The above described block mode enables simple and thus economical implementation of the motorized lifting of the ratchet 2 especially with respect to control engineering.

With the above described implementation of motorized lifting of the ratchet 2, the manual lifting of the ratchet 2, for example, for emergency actuation, can be implemented especially easily. For this reason, the second end 13 of the traction mechanism 5 is coupled to the emergency actuation mechanism 12 by drive engineering.

By means of the emergency actuation means 12, a manual driving force can be applied to the second end 13 of the traction mechanism 5. This driving force is aligned essentially parallel to the extension of the traction mechanism 5 on its second end 13 and again causes lifting of the ratchet 2. In the embodiment shown in FIG. 5(a), actuation of the emergency actuation means 12 causes displacement of the second end 13 of the traction mechanism 5 to the right. The abutment for the motorized lifting of the ratchet 2 is made available again here by a stopper element 17.

It can be taken from FIGS. 5(a) & 5(b) that, in turn, only a single mechanism is necessary to implement the motorized lifting of the ratchet 2, on the one hand, and the manual lifting of the ratchet 2, on the other.

Similar to the embodiment shown in FIGS. 1 to 3, here, the traction mechanism 5 can also be made as a cable, belt or chain. In an especially preferred configuration the traction mechanism 5 extends along a straight line when the opening drive 4 has not been actuated (FIG. 5a)). When the opening drive 4 is actuated (FIG. 5b)) the first end 11 of the traction mechanism 5, the engagement point 24 on the traction mechanism 5 and the second end 13 of the traction mechanism 5 form the corner points of a triangle. This is a necessary consequence of the above described operating principle of delivering a vertically aligned driving force 25 to the traction mechanism 5.

It is apparent from FIG. 5(a) that the traction mechanism 5 extends in the direction perpendicular to the ratchet axis 20 when the opening drive 4 has not been actuated. This is especially advantageous in the sense of optimum delivery of a driving force to the ratchet 2.

It is pointed out that, in the embodiment shown in FIGS. 4 to 6, the function of motorized lifting of the ratchet 2 and of manual lifting of the ratchet 2 can be interchanged. This means that it is also possible to deliver to the traction mechanism 5 a manual driving force aligned perpendicular to the extension of the traction mechanism 5 and the motorized lifting of the ratchet 2, accordingly, parallel to the traction mechanism 5.

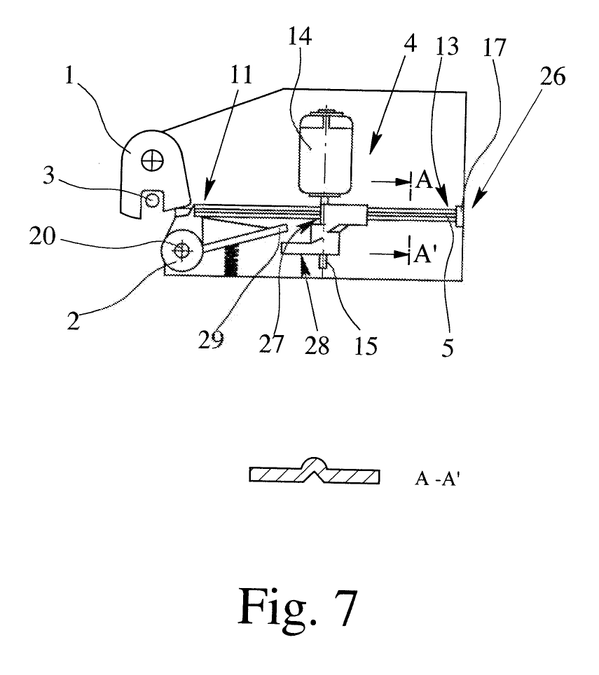

FIG. 7 shows another preferred embodiment according to another independent teaching. Here, the traction mechanism 5 is made elastically flexible, and in this respect, can also transmit compressive forces within predefined limits. Therefore, it is not a traction mechanism 5 in the conventional sense here. Otherwise, the embodiment shown in FIG. 7 corresponds to the embodiment shown in FIGS. 4 to 6. Reference should be made to the details there.

The embodiment shown in FIG. 7 has a traction mechanism 5 which is made as a band, preferably a metal band. The band has a cross section by which the band has the characteristic of a spring.

The band 5 is coupled, on the one hand, to the ratchet 2, and on the other, to an abutment 26. The elastic configuration of the band 5 causes the belt 5 to act as a ratchet spring that pretensions the ratchet 2 into its engaged position. At the same time, the band 5 acts in the same manner as the traction mechanism 5 shown in FIGS. 4 to 6. A driving force delivered perpendicular to the extension of the band 5 therefore also causes the lifting of the ratchet 2 here. In this respect, reference should be made to the details above.

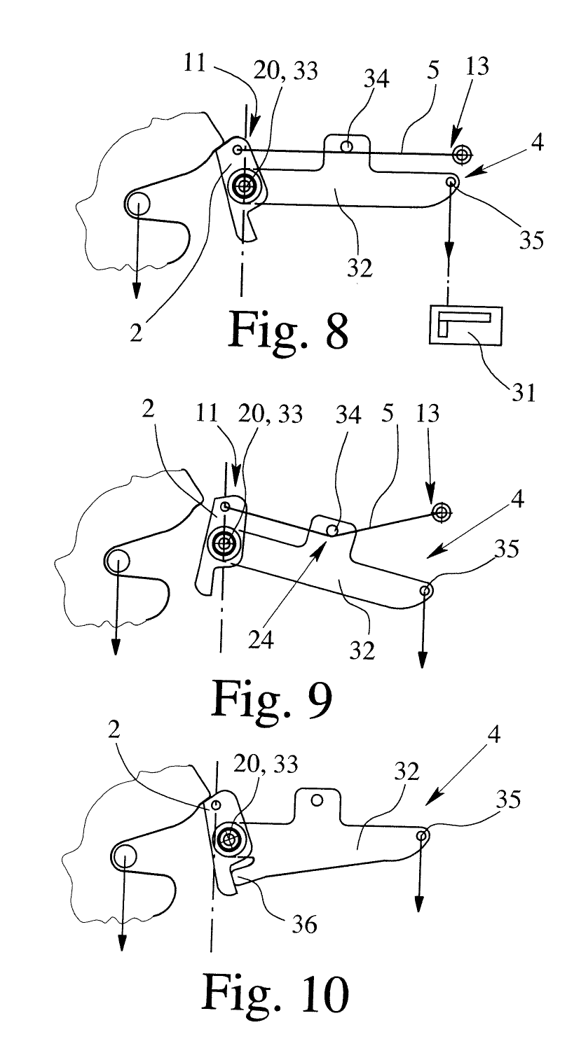

For clarification, it is pointed out that the opening drive 4 can be made not only motorized, but also to be manually actuated, and that by means of the opening drive 4 at the engagement point 24 between the two ends 11, 13 of the traction mechanism 5, the manual driving force can be transmitted to the traction mechanism 5. In an especially preferred configuration, the manual driving force goes back to the actuation of an inside door handle 31 or an outside door handle. This is shown schematically in FIG. 8.

In this connection, it must be considered that the embodiment shown in FIG. 8 can also relate to a motorized opening drive 4. For this reason, the connection to the inside actuating lever 31 shown there is illustrated by a dot-dash line.

In the preferred embodiment shown in FIGS. 8 & 9, the opening drive 4 has an actuating lever 32 which can be pivoted around an actuating lever axis 33 when the opening drive 4 is actuated. The actuating lever 32 also has an engagement element 34 for engaging the traction mechanism 5. Finally, the actuating lever 32, in the figure, is provided with a point of application of force 35 apart from the actuating lever axis 33 for delivering a manual or motorized actuating force. A Bowden cable, for example, can be coupled to the point of application of force 35. However, it can also be provided that any motorized driving means acts directly on the point of application of force 35.

Numerous versions are possible for the configuration of the engagement element 34. Preferred examples of this are the configuration of the engagement element 34 as a mandrel, as a guide pulley or as a preferably circular segment-shaped groove.

It can be taken from FIGS. 8 & 9 that the engagement element 34 on the actuating lever 32 is located between the actuating lever axis 33 and the point of application of force 35 viewed in the direction of extension of the actuating lever 32. The location of the engagement element 34 on the actuating lever 32, of course, has effects on the location of the engagement point 24 on the traction mechanism 5. This applies quite generally to all illustrated embodiments.

In a preferred configuration, the engagement point 24 is located roughly in the middle between the first end 11 of the traction mechanism 5 and the second end 13 of the traction mechanism 5. However, it can also be advantageous for the engagement point 24, viewed from the first end 11 of the traction mechanism 5 to the second end 13 of the traction mechanism 5, to be located roughly in the front half of the traction mechanism 5, preferably in the front third of the traction mechanism 5. One alternative calls for the engagement point 24, viewed from the first end 11 of the traction mechanism 5 to the second end 13 of the traction mechanism 5, to be located roughly in the back half of the traction mechanism 5, preferably in the back third of the traction mechanism 5. The transmission ratios which can be achieved by the arrangement can be largely set at will by variation of the location of the engagement point 24 on the traction mechanism 5.

It can also be advantageous for the engagement point 24 as addressed above to be displaced along the traction mechanism 5 during actuation of the opening drive 4. Then, the resulting multiplication changes during actuation of the opening drive 4; this can be advantageous when the ratchet 2 is raised. Generally, when the ratchet 2 is raised, it is specifically such that what is initially important is high torque and then high positioning speed. This can be fundamentally done with the above described displacement of the engagement point 24.

In the preferred embodiment shown in FIGS. 8 & 9, it is such that the ratchet 2 can be pivoted around a ratchet axis 20 and that the ratchet axis 20 and the actuating element axis 33 are aligned relative to one another. This means that the two axes 20, 33 are flush with one another in a geometrical respect. However, fundamentally, it can also be provided that the physical axes of the ratchet 2 corresponding to one another, on the one hand, and of the actuating lever 32, on the other, are identical. Basically, it is provided that the ratchet 2, on the one hand, and the actuating lever 32, on the other hand, can be pivoted independently of one another, if they are not coupled by way of the traction mechanism 5.

One especially compact arrangement arises in that the arrangement is made such that when the opening drive 4 is not actuated, the point of application of force 35 of the actuating lever 32 in any case in a projection viewed in the direction of the actuating lever axis 33 is located in the vicinity of the second end 13 of the traction mechanism 5. This is shown in FIG. 8.

FIG. 8 also shows that the connecting line between the actuating lever axis 33 and the point of application of force 35, which line is aligned perpendicular to the actuating lever axis 33, is located essentially parallel to the direction of extension of the traction mechanism 5 when the opening drive 4 is not actuated. Other versions are also conceivable here.

It is pointed out that the second end 13 of the traction mechanism 5 shown in FIGS. 8 & 9 can also fundamentally be provided with an emergency actuating means for manually lifting the ratchet 2, as is shown in FIGS. 4 & 5. In this connection, the functions of motorized lifting of the ratchet 2 and of manual lifting of the ratchet 2 can be interchanged, as was explained in conjunction with FIGS. 4 to 6. However, there need not necessarily be this emergency actuation means.

FIG. 9 shows the situation with the opening drive actuated, therefore with the actuating lever 32 pivoted. The engagement element 34 is engaged here with the traction mechanism 5 and applies a driving force to the traction mechanism 5 that is aligned essentially perpendicular to the extension of the traction mechanism 5, by which the traction mechanism 5 is deflected down in FIG. 9. Because the traction mechanism 5 is fixed on its second end 13, the ratchet 2 is raised again.

It can be easily recognized in FIG. 9 that the ratchet 2 together with the traction mechanism 5, to a certain extent, forms a four-bar mechanism, the joints of the four-bar kinematics being formed by the ratchet axis 20, the first end 11 of the traction mechanism 5, the engagement point 24 and the second end 13 of the traction mechanism 5. The traction mechanism 5 therefore to a certain extent forms two levers of the four-bar kinematics and acts as a toggle lever with correspondingly high multiplication according to a combined examination of FIGS. 8 & 9. The same consideration applies, of course, to the embodiments shown in FIGS. 4 to 7.

In the design of the arrangement, it must be considered that what is important is simply applying to the traction mechanism 5 a driving force which is aligned essentially perpendicular to the traction mechanism 5. Otherwise, the alignment of the driving force can be selected largely freely, if this is mechanically feasible.

One special advantage of the embodiment shown in FIGS. 8 & 9 is that the same structural execution can be used for implementation of a second version. The actuating lever 32 is made specifically such that it can be equipped with a driver 36 which engages the ratchet 2 and lifts it when the actuating lever 32 pivots and the traction mechanism 5 is omitted. In this connection, the driver 36 is preferably made as a simple driving lug and thus again leads to a compact arrangement. This could be a low-cost version for the motor vehicle lock shown in FIGS. 8 & 9. This low-cost version is shown in FIG. 10.

It is this possible to produce, on the one hand, the version shown in FIGS. 8 & 9, and on the other, the version shown in FIG. 10, on the same production facility. In doing so, simply a slightly altered actuating lever 32 can be used. Furthermore, depending on the version, optionally, the traction mechanism 5 shown in FIGS. 8 & 9 can be used or simply omitted.

It is noteworthy that the actuating direction of the actuating lever 32 when the ratchet 2 is raised via the traction mechanism 5 (FIGS. 8 & 9) corresponds to the actuating direction of the actuating lever 32 when the ratchet 2 is raised via the driver 36 (FIG. 10). This results in that the connection of the actuating lever 32 for both the above explained versions can be identical. This is advantageous for purposes of a modular structure.

It also pointed out that all the illustrated embodiments, especially the embodiments shown in FIGS. 4 to 10, can be implemented with especially few parts. This is due, first of all, to the traction mechanism 5 replacing at least two levers of the lever kinematics in the embodiments shown in FIGS. 4 to 9.

What is claimed is:

1. Motor vehicle lock, comprising:
a latch,
a ratchet,
an opening drive for motorized lifting of the ratchet, and
a guide pulley which is located on one of the ratchet and a rocker arm connected to the ratchet,
a flexible traction mechanism, the traction mechanism being guided via the guide pulley for lifting of the ratchet,
wherein the traction mechanism is coupled on its first end to the opening drive so as to be drivable thereby, and
wherein a emergency actuation means for manually lifting the ratchet is coupled to a second end of the traction mechanism.

2. Motor vehicle lock in accordance with claim 1, wherein the opening drive (4) makes available an abutment for the manual driving force of the emergency actuation means (12) and wherein the emergency actuation means (12) makes available an abutment for the motorized driving force of the opening drive (4).

3. Motor vehicle lock in accordance with claim 1, wherein the opening drive comprises a drive motor with a drive shaft and wherein the traction mechanism is windable on the drive shaft.

4. Motor vehicle lock in accordance with claim 2, wherein emergency actuation means comprises a stopper element which is permanently connected to the traction mechanism and which engages a stop when the emergency actuation means is not actuated and which provides abutment for the motorized driving force of the opening drive.

5. Motor vehicle lock in accordance with claim 1, wherein the ratchet is pivotable around a ratchet axis, wherein the guide pulley is pivotable around a deflection axis, and wherein the ratchet axis and the deflection axis are aligned essentially parallel to one another.

6. Motor vehicle lock in accordance with claim 1, wherein a traction mechanism segment between the opening drive and the guide pulley includes an angle with a traction mechanism segment between the emergency actuation means and the guide pulley which is less than 120° when the ratchet is engaged

7. Motor vehicle lock in accordance with claim 1, wherein the traction mechanism is one of a cable, a belt and a chain.

8. Motor vehicle lock, comprising:
a latch,
a ratchet,
an opening drive for lifting of the ratchet, and
a flexible traction mechanism, via which the opening drive is coupled or can be coupled to the ratchet, the traction mechanism being coupled on its first end to one of the ratchet and a rocker arm connected to the ratchet, and being supported on a second end,
wherein the opening drive is operable for applying a driving force on the traction mechanism which is directed essentially perpendicular to a direction of extension of the traction mechanism at an engagement point located between the ends of the traction mechanism and which is transmitted by the traction mechanism to cause lifting of the ratchet.

9. Motor vehicle lock in accordance with claim 8, wherein the opening drive is a motorized opening drive which transmits a motorized driving force to the traction mechanism.

10. Motor vehicle lock in accordance with claim 8, wherein the traction mechanism is tensioned between the ratchet and an abutment.

11. Motor vehicle lock in accordance with claim 8, wherein the opening drive comprises a drive motor with a drive shaft and wherein the drive shaft bears a cam arrangement for transmitting a driving force from the opening drive to the traction mechanism.

12. Motor vehicle lock in accordance with claim 11, wherein the cam arrangement has a stop which engages the ratchet when the ratchet is in the raised position and blocks the drive shaft in a blocking position.

13. Motor vehicle lock in accordance with claim 8, further comprising an emergency actuation means for manually lifting the ratchet, wherein the traction mechanism is coupled to the emergency actuation means at a second end so as to be driven thereby.

14. Motor vehicle lock in accordance with claim 13, wherein the emergency actuation means is operable for applying a manual driving force to the second end of the traction mechanism that is aligned essentially parallel to a direction of extension of the traction mechanism for causing lifting of the ratchet.

15. Motor vehicle lock in accordance with claim 8, wherein the traction mechanism is one of a cable, a belt and a chain.

16. Motor vehicle lock in accordance with claim 15, wherein the traction mechanism extends along a straight line when the opening drive is not actuated, and with the opening drive actuated, the first end of the traction mechanism, the engagement point on the traction mechanism and the second end of the traction mechanism form the corner points of a triangle.

17. Motor vehicle lock in accordance with claim 8, wherein the traction mechanism is elastically flexible and can also transmit compressive forces within predefined limits.

18. Motor vehicle lock in accordance with claim 8, wherein the opening drive is manually actuatable for applying the driving force to the traction mechanism at said engagement point.

19. Motor vehicle lock in accordance with claim 8, wherein the opening drive is equipped with an actuating lever which pivots around an actuating lever axis when the opening drive is actuated and which has an engagement element for engaging the traction mechanism for applying a driving force at a point of force application that is at a distance from the actuating lever axis.

20. Motor vehicle lock in accordance with claim 19, wherein the engagement element is one of a mandrel, a guide pulley, and a circular segment-shaped groove.

21. Motor vehicle lock in accordance with claim 19, wherein the engagement element on the actuating lever is located between the actuating lever axis and the point of application of force.

22. Motor vehicle lock in accordance with claim 8, wherein the engagement point is located roughly in the middle between the first end of the traction mechanism and the second end of the traction mechanism.

23. Motor vehicle lock in accordance with claim 8, wherein the engagement point, viewed from the first end of the traction mechanism toward the second end of the traction mechanism is located roughly in a front half of the traction mechanism.

24. Motor vehicle lock in accordance with claim 8, wherein the engagement point viewed from the first end of the traction mechanism toward the second end of the traction mechanism is located roughly in a back half of the traction mechanism.

25. Motor vehicle lock in accordance with claim 19, wherein the ratchet is pivotable around a ratchet axis and wherein the ratchet axis and the actuating lever axis are aligned relative to one another.

26. Motor vehicle lock in accordance with claim 19, wherein, when the opening drive is not actuated, the point of application of force onto the actuating lever, in a projection viewed in a direction of the actuating lever axis is located in the vicinity of the second end of the traction mechanism.

27. Motor vehicle lock in accordance with claim 19, wherein a connecting line between the actuating lever axis and the point of application of force onto the actuating lever, which is aligned perpendicular to the actuating lever axis, is located essentially parallel to the direction of extension of the traction mechanism when the opening drive is not actuated.

28. Motor vehicle lock in accordance with claim 19, wherein the actuating lever is equipped with a driver which engages the ratchet and raises it when the actuating lever pivots.

29. Motor vehicle lock in accordance with claim 28, wherein the driver is a driving lug.

30. Motor vehicle lock in accordance with claim 28, wherein an actuating direction of the actuating lever when the ratchet is raised via the traction mechanism corresponds to an actuating direction of the actuating lever when the ratchet is raised via the driver.
